(19) United States
(12) Patent Application Publication
(10) Pub. No.: US 2021/0217382 A1
(43) Pub. Date: Jul. 15, 2021

(54) CALIBRATION DEVICE AND CALIBRATION METHOD

(71) Applicant: SAKAI DISPLAY PRODUCTS CORPORATION, Sakai-shi, Osaka (JP)

(72) Inventors: RYUSUKE HORIBE, Sakai-shi, Osaka (JP); YUTO KIMURA, Sakai-shi, Osaka (JP)

(21) Appl. No.: 17/055,361

(22) PCT Filed: May 15, 2018
(86) PCT No.: PCT/JP2018/018762

§ 371 Date: Nov. 13, 2020

(51) Int. Cl. G09G 5/10; G09G 3/36

(52) U.S. Cl. CPC G09G 5/10; G09G 3/3614; G09G 2320/0693; G09G 3/3688; G09G 2310/08; G09G 2320/041; G09G 3/3677; G09G 2320/0233

(57) ABSTRACT

Display cells are selected in units of rows by first control signals applied via a first signal lines. The display cells display an image in accordance with a plurality of second control signals applied via a plurality of second signal lines. A photographing device photographs a screen of the display panel. An arithmetic unit causes the display panel to display a test image. Based on the luminance of first and second regions in the test image displayed on the display panel and photographed by the photographing device, the arithmetic unit sets the delay amount of second control signals for the display cells included in the second region relative to second control signals for the display cells included in the first region such that the luminance of the second region satisfies a predetermined standard with respect to the luminance of the first region.

### TECHNICAL FIELD

The invention relates to a calibration apparatus and a calibration method to calibrate a display apparatus.

### BACKGROUND ART

In recent years, a display panel such as a liquid crystal panel has been gradually increasing in size, and the resolution and frame rate thereof have also been gradually increasing.

### PRIOR ART DOCUMENT

### Patent Documents

Patent Document 1: JP 2003-162262 A

Patent Document 2: JP 2009-014897 A

### SUMMARY OF THE INVENTION

### Problem to be Solved by the Invention

As a display panel increases in size, the length of a signal line to drive each of display cells thereof increases, thus causing the delay amount of a signal transmitted via the signal line to increase. For example, in a gate control signal to turn on and off a switching element of each of the display cells, the time difference, in the rise and the fall of the gate control signal, between at a position in proximity to a gate drive circuit (the edge of the display panel) and at a position being remote from the gate drive circuit (the central portion of the display panel) becomes remarkable.

To reduce such an effect, it is considered to correct the timing at which image data is supplied to each of the display cells in accordance with the delay amount of the gate control signal (See Patent Documents 1 and 2, for example.)

However, there are manufacturing variations for the signal line of the display panel, so that a delay of a signal varies for each of individual products, possibly causing an occurrence of variations in luminance (grayscale) in a screen of the display panel for each of the individual products.

An object of the invention is to provide a calibration apparatus and a calibration method being novel, the calibration apparatus and the calibration method to calibrate a display apparatus so as to solve the above-described problems and reduce variations in luminance in a screen of a display panel.

### Means to Solve the Problem

According to one aspect of the invention, a calibration apparatus to calibrate a display apparatus is provided. The display apparatus comprises a display panel comprising a plurality of first signal lines along a plurality of rows, a plurality of second signal lines along a plurality of columns, and a plurality of display cells being connected to the first signal lines and the second signal lines, respectively. Each of the display cells is selected for each of the rows by a plurality of first control signals applied via the plurality of first signal lines. Each of the display cells displays each pixel of an image along one of the plurality of rows in accordance with a plurality of second control signals applied via a plurality of second signal lines. The calibration apparatus comprises a photographing apparatus to photograph a screen of the display panel; and an arithmetic unit to cause the display panel to display a test image and set a delay amount of the second control signal for the display cell included in a second region relative to the second control signal for the display cell included in a first region such that luminance of the second region satisfies a predetermined standard with respect to luminance of the first region, based on luminances of the first region and the second region of a test image that is displayed on the display panel and photographed by the photographic apparatus.

### Effects of the Invention

The calibration apparatus and calibration method according to the invention make it possible to calibrate a display apparatus so as to reduce variations in luminance within a screen of a display panel by setting a delay amount of a second control signal based on a test image being displayed on the display panel and photographed by a photographing apparatus.

### BRIEF DESCRIPTION OF THE DRAWINGS

FIG. 1 shows a block diagram of the configuration of a display apparatus, an arithmetic unit, and a photographing apparatus according to a first embodiment.

FIG. 2 shows a block diagram of the detailed configuration of the display apparatus in FIG. 1.

FIG. 3 shows a circuit diagram of the detailed configuration of a display cell in FIG. 2.

FIG. 4 shows an equivalent circuit of one gate signal line in FIG. 2.

FIG. 5 schematically shows a delay occurring in a display panel in FIG. 1.

FIG. 6 shows a timing chart of an ideal operation of the display cell in a case of driving the display panel in FIG. 1 with a dot inversion scheme.

FIG. 7 shows a timing chart of an operation of the display cell when the delay occurs with rounding of a gate control signal in a case of driving the display panel in FIG. 1 with the dot inversion scheme.

FIG. 8 shows the display panel when the delay occurs with rounding of the gate control signal in a case of driving the display panel in FIG. 1 with the dot inversion scheme to display a test image being white as the entire image.

FIG. 9 shows a timing chart of an operation of the display cell when a source control signal is delayed in accordance with the delay occurring in the gate control signal in the case of driving the display panel in FIG. 1 with the dot inversion scheme.

FIG. 10 shows a timing chart of an ideal operation of the display cell in a case of driving the display panel in FIG. 1 with a vertical line inversion scheme.

FIG. 11 shows a timing chart of an operation of the display cell when the delay occurs with rounding of the gate control signal in the case of driving the display panel in FIG. 1 with the vertical line inversion scheme.

FIG. 12 shows the display panel when the delay occurs with rounding of the gate control signal in a case of driving the display panel in FIG. 1 with the vertical line inversion scheme to display a black and white stripe image.

FIG. 13 shows a timing chart of the operation of the display cell when the source control signal is delayed in accordance with the delay occurring in the gate control signal in a case of driving the display panel in FIG. 1 with the vertical line inversion scheme.

FIG. 14 shows a flowchart of a calibration process to be executed by the arithmetic unit in FIG. 1.

FIG. 15 shows a flowchart of an initialization process to be executed by the display apparatus in FIG. 1.

FIG. 16 shows a block diagram of the configuration of the display apparatus, the arithmetic unit, and the photographing apparatus according to a second embodiment.

FIG. 17 shows a graph of the drain current characteristics with respect to the gate-source voltage for each switching element of the display panel in FIG. 16.

FIG. 18 shows a graph of the gate threshold voltage characteristics with respect to the channel temperature for each switching element of the display panel in FIG. 16.

FIG. 19 shows a flowchart of the calibration process to be executed by the arithmetic unit in FIG. 16.

FIG. 20 shows a flowchart of the initialization process to be executed by the display apparatus in FIG. 16.

FIG. 21 shows a diagram to explain a method to set a delay amount of the source control signal in the display apparatus in FIG. 1.

FIG. 22 shows a block diagram of the detailed configuration of the source drive circuit in FIG. 21.

FIG. 23 shows a graph of the delay amount being set to the source control signal transmitted via each source signal line in FIG. 22.

FIG. 24 shows a graph of synthesis of the delay amounts in each of the source drive circuits in FIG. 1.

FIG. 25 shows a diagram to explain the method to set the delay amount of the source control signal in the display apparatus according to a variation of the first embodiment.

### EMBODIMENT FOR CARRYING OUT THE INVENTION

Below, a calibration apparatus and a calibration method of a display apparatus according to each embodiment of the invention are described with reference to the drawings. In each FIG., the same letters indicate the same constituting elements.

### First Embodiment

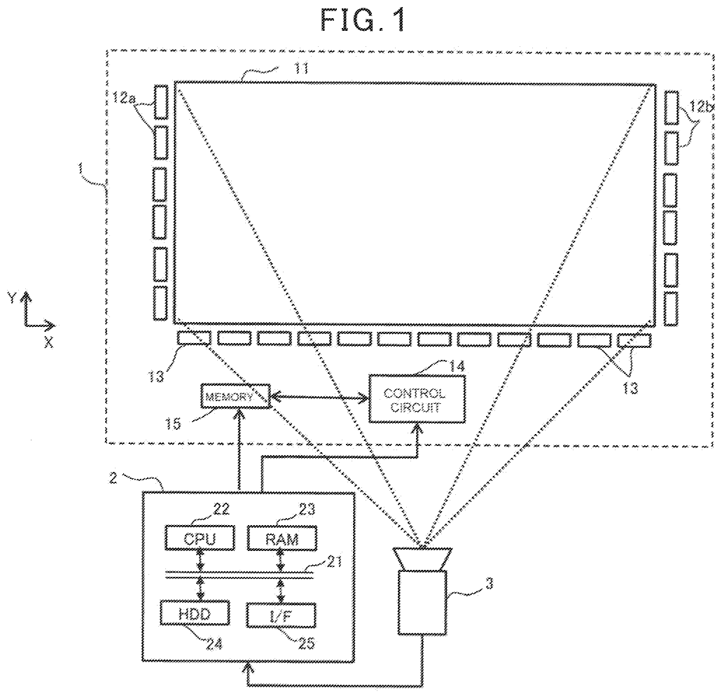

FIG. 1 shows a block diagram of the configuration of a display apparatus 1, an arithmetic unit 2, and a photographing apparatus 3 according to a first embodiment. The arithmetic unit 2 and the photographing apparatus 3 operate as a calibration apparatus to calibrate the display apparatus 1 so as to reduce variations in luminance.

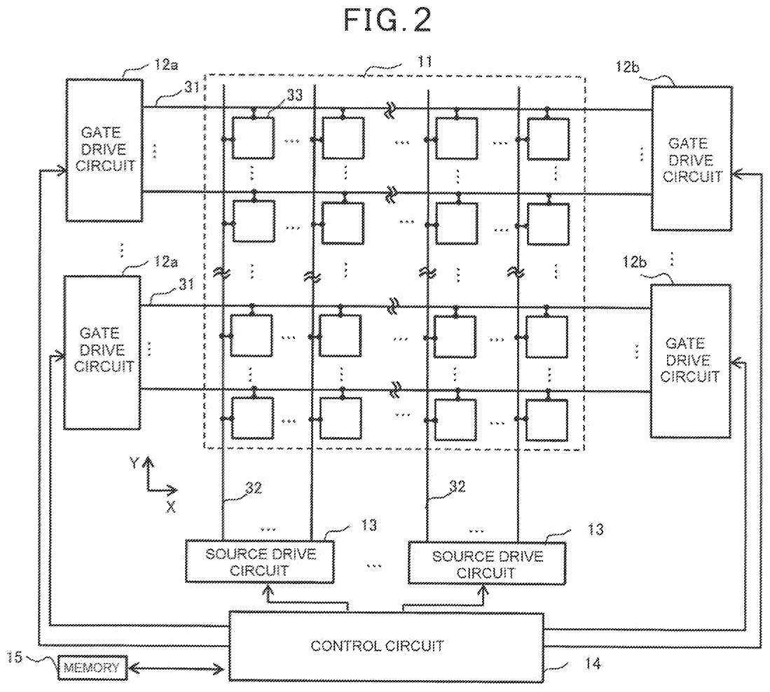

The display apparatus 1 comprises a display panel 11, a plurality of gate drive units 12a, 12b, a plurality of source drive circuits 13, a control circuit 14, and a memory 15. The display panel 11 comprises a plurality of display cells 33 (see FIG. 2) being lined up along a row direction (an X direction in FIG. 1) and along a column direction (a Y direction in FIG. 1). The display panel 11 comprises a rectangular screen. The display panel 11 is a liquid crystal panel, for example. The gate drive circuits 12a, 12b supply a plurality of gate control signals to each of the display cells 33 of the display panel 11, the plurality of gate control signals to select each of the display cells 33 for each row. Here, “select” means to connect a capacitor and a display element inside the display cell 33 to a source signal line 32 (see FIG. 2) by turning on a switching element (described below) of the display cell 33. The source drive circuit 13 supplies a plurality of source control signals, via the plurality of source signal line 32, to each of the display cells 33 with a plurality of variable delay amounts, the plurality of source control signals indicating the grayscale of each pixel of an image along one of a plurality of rows. The control circuit 14 controls the gate drive circuits 12a, 12b and the source drive circuits 13. The control circuit 14 is also called a timing controller. The memory 15 is a non-volatile storage medium to store therein various parameters related to the operation of the display apparatus 1, such as the delay amount of the source control signal. The control circuit 14 controls an overall operation of the display apparatus 1 based on the parameters stored in the memory 15.

The arithmetic unit 2 comprises a bus 21, a central processing unit (CPU) 22, a random access memory (RAM) 23, a hard disk drive (HDD) 24, and an interface (I/F) 25. The central processing unit 22, the random access memory 23, the hard disk drive 24, and the interface 25 are mutually connected via the bus 21. The hard disk drive 24 stores therein programs and data related to the operation of the arithmetic unit 2. The central processing unit 22 reads the programs and data from the hard disk drive 24 and executes the read programs in the random access memory 23. Other storage apparatuses such as a solid state memory can be provided in replacement of the hard disk drive 24. The interface 25 comprises an HDMI (registered trademark), Ethernet (registered trademark), USB, and mutually connects the arithmetic unit 2, and the display apparatus 1 and the photographing apparatus 3.

The photographing apparatus 3 is provided so as to photograph the entire screen of the display panel 11. The photographing apparatus 3 sends a photographed image to the arithmetic unit 2.

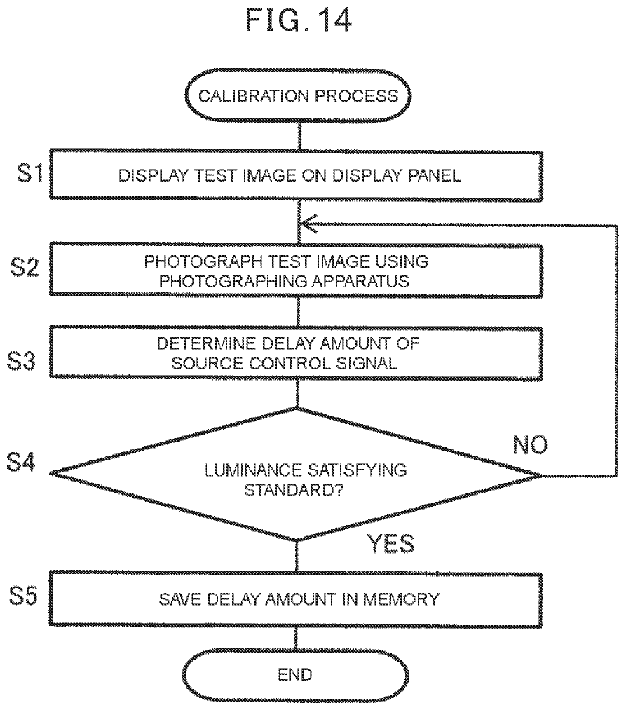

Based on the image photographed by the photographing apparatus 3, the central processing unit 22 of the arithmetic unit 2 executes a calibration process to be described below with reference to FIG. 14 and calibrates the display apparatus 1.

The arithmetic unit 2 can be a general purpose computer, or a dedicated apparatus to calibrate the display apparatus 1.

FIG. 2 shows a block diagram of the detailed configuration of the display apparatus 1 in FIG. 1. The display panel 11 comprises a plurality of gate signal lines 31 along a plurality of rows, a plurality of source signal lines 32 along a plurality of columns, and a plurality of display cells 33 being connected to the plurality of gate signal lines 31 and the plurality of source signal lines 32, respectively. Each of the gate drive circuits 12a, 12b supplies a plurality of gate control signals to each of the display cells 33 via the plurality of gate signal lines 31, the plurality of gate control signals to select each of the display cell 33 for each of the rows. Each source drive circuit 13 supplies a plurality of source control signals to each of the display cell 33 via the plurality of source signal lines 32 with a plurality of variable delay amounts, the plurality of source control signals indicating the grayscale of each pixel of an image along one of the plurality of rows. The gate drive circuit 12a is provided at the left side of the display panel 11, at the right side of the display panel 11 is also provided the gate drive circuit 12b, and the gate drive circuits 12a, 12b are connected to the opposite ends of each of the gate signal lines 31, respectively. In the specification, the gate drive circuits 12a, 12b are also collectively called “the gate drive circuits 12”. Moreover, the source drive circuit 13 is provided at the lower side of the display panel 11.

The display panel 11 is driven with a dot inversion scheme, a horizontal line inversion scheme, or a vertical line inversion scheme, for example. In the dot inversion scheme, a voltage having the polarity to be inverted for each of the rows, for each of the columns, and for each frame is applied to each of the display cells 33. Moreover, in the horizontal line inversion scheme, a voltage having the polarity to be inverted for each predetermined number of rows and for each frame is applied to each of the display cells 33. Furthermore, in the vertical line inversion scheme, a voltage having the polarity to be inverted for each predetermined number of columns and for each frame is applied to each of the display cells 33.

In the specification, the gate drive circuit 12, the gate signal line 31, and the gate control signal are also called “a first drive circuit”, “a first signal line” and “a first control signal”, respectively. Moreover, in the specification, the source drive circuit 13, the source signal line 32, and the source control signal are also called “a second drive circuit”, “a second signal line” and “a second control signal”, respectively.

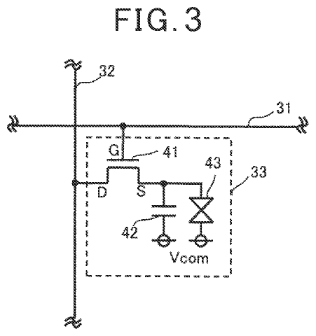

FIG. 3 shows a circuit diagram of the detailed configuration of the display cell 33 in FIG. 2. The display cell 33 comprises a switching element 41, a capacitor 42, and a display element 43. The switching element 41 is turned on and off in accordance with the gate control signal. The switching element 41 is a thin film transistor, for example. The capacitor 42 and the display element 43 are connected in parallel with each other, one ends of the capacitor 42 and the display element 43 being connected to the source signal line 32 via the switching element 41 and the other ends thereof being connected to a terminal of a predetermined common voltage Vcom. The capacitor 42 is a capacitive element to be charged in accordance with the voltage of the source control signal. The display element 43 has an optical property that varies in accordance with the voltage across the capacitor 42. The display element 43 is a liquid crystal, for example.

The gate control signal input to the display panel 11 from the gate drive circuits 12a, 12b propagates through the gate signal line 31 and is applied to the gate terminal of the switching element 41 of each of the display cells 33. Moreover, the source control signal input to the display panel 11 from the source drive circuit 13 propagates through the source signal line 32 and is applied to the drain terminal of the switching element 41 of each of the display cells 33. When the voltage of the gate control signal being applied to the gate terminal of the switching element 41 rises to exceed a threshold voltage Vth of the switching element 41, the switching element 41 is turned on to cause the drain and the source to conduct therebetween. Here, the voltage of the source control signal being applied to the drain terminal of the switching element 41 is supplied to the display cell 33 through the source terminal of the switching element 41, causing the capacitor 42 to be charged (or discharged) in accordance with the voltage of the source control signal.

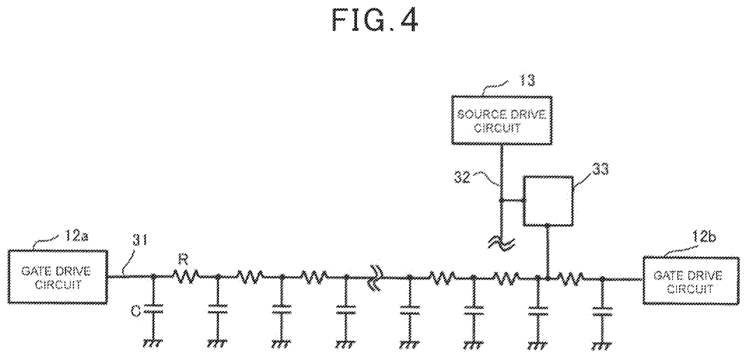

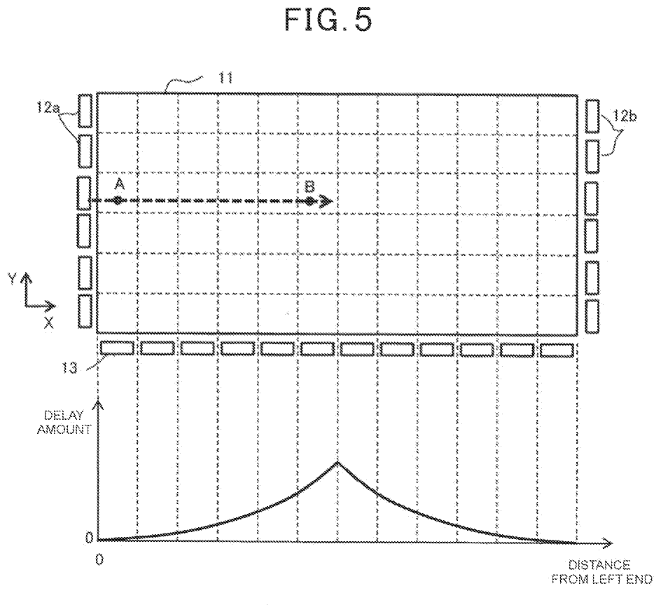

Next, with reference to FIGS. 4 and 5, a delay of the gate control signal being transmitted via each of the gate signal lines 31 is described.

FIG. 4 shows an equivalent circuit of the one gate signal line 31 in FIG. 2. The gate signal line 31 has its own resistance R. Moreover, a capacitance C (a parasitic capacitance) occurs between the gate signal line 31 and a conductor in proximity thereto. The gate signal line 31 is a distributed constant circuit having the resistance R and the capacitance C and has a time constant being determined by the resistance R and the capacitance C. In other words, the gate signal line 31 functions as a low pass filter, so that, as the gate control signal propagates on the gate signal line 31, rounding of the waveform thereof increases.

FIG. 5 schematically shows a delay occurring in the display panel 11 inn FIG. 1. As described previously, as the size of the display panel 11 increases, the delay amount of a signal transmitted via the signal line increases. Moreover, in a case that the display panel 11 has a size being greater than or equal to 40 inches in particular, the length of the gate signal line 31 increases and, therefore, the resistance R and the capacitance C thereof increase, causing rounding of the waveform of the gate control signal to increase. When rounding occurs in the waveform of the gate control signal, the timing at which the voltage of the gate control signal exceeds and/or falls below the threshold voltage of the switching element 41, or in other words, the timing at which the switching element 41 is turned on and/or off is delayed, causing an occurrence of an effect being equivalent to a case in which the gate control signal itself is delayed. The delay caused by the gate signal line 31 increases toward the position at the central portion of the display panel 11 (for example, a display cell B) from the positions in proximity to the gate drive circuits 12a, 12b, or, in other words, the positions at the left and right sides of the display panel 11 (for example, a display cell A) as shown in FIG. 5 due to the effect of the resistance R and the capacitance C (distributed constant) of the gate signal line 31. Due to such an effect, in a case that the display panel 11 is driven with the dot inversion scheme or the horizontal line inversion scheme, the central portion of the display panel 11 is brought to be dark. Moreover, in a case that the display panel 11 is driven with the vertical line inversion scheme and horizontal stripes are displayed, ghost is generated at the central portion of the display panel 11 due to the capacitor 42 of a certain display cell 33 being charged with the voltage of the source control signal to be supplied to the capacitor 42 of the display cell 33 of an adjacent row.

On the contrary, according to the first embodiment, the source drive circuit 13 corresponding to each of the display cells 33 delays the timing to output the source control signal in alignment with a delay of the gate control signal at the position of each of the display cells 33. More specifically, the arithmetic unit 2 causes the display panel 11 to display thereon a test image and the test image displayed on the display panel 11 is photographed by the photographic apparatus 3. Next, based on luminances of predetermined reference and target regions of the photographed test image, the arithmetic unit 2 determines a delay amount of the source control signal for the display cell 33 included in the target region relative to the source control signal for the display cell 33 included in the reference region such that the luminance of the target region satisfies a predetermined standard with respect to the luminance of the reference region. The arithmetic unit 2 sets the determined delay amount of the source control signal to the display apparatus 1 and thereby calibrates the display apparatus 1 so as to reduce variations in luminance in the screen of the display panel 11. Here, the reference region is a region in proximity to the gate drive circuits 12a, 12b such as a region in proximity to the display cell A, for example. Moreover, the target region is an arbitrary region including a display cell whose luminance is to be adjusted of display cells being connected to the same gate signal line 31 as a display cell included in the reference region such as a region in proximity to the display cell B, for example. In the specification, the reference region is called “a first region”, while the target region is called “a second region”.

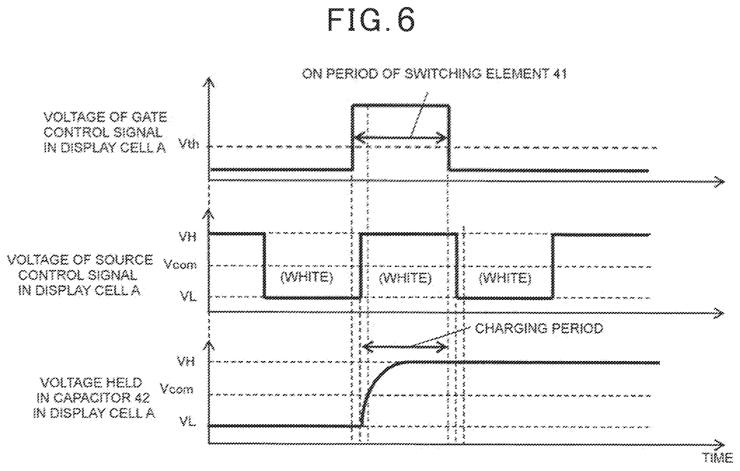

Next, a delay amount of the source control signal to be determined by the calibration apparatus according to the first embodiment is described in detail with reference to FIGS. 6 to 13.

First, with reference to FIGS. 6 to 9, an operation of the display cell 33, a delay of the gate control signal, and determining of a delay amount of the source control signal in a case of driving the display panel 11 in FIG. 1 with the dot inversion scheme are described.

With the dot inversion scheme, the polarity of the voltage applied to each of the display cells 33 is inverted for mutually adjacent gate signal lines 31, is inverted for mutually adjacent source signal lines 32, and is inverted for each frame. Moreover, with the dot inversion scheme, the test image has luminance being uniform for the entire image, so that, for example, a test image being white for the entire image is used.

FIG. 6 shows a timing chart of an ideal operation of the display cell 33 in a case of driving the display panel 11 in FIG. 1 with the dot inversion scheme. A first stage in FIG. 6 shows the voltage of the gate control signal to be applied to the gate terminal of the switching element 41 in the display cell A in FIG. 5. A second stage shows the voltage of the source control signal to be applied to the drain terminal of the switching element 41 in the display cell A in FIG. 5. A third stage in FIG. 6 shows the voltage being held in the capacitor 42 in the display cell A in FIG. 5.

With reference to the first stage in FIG. 6, the gate control signal has a voltage of between −10V and −6V at a low level and a voltage of between 20V and 35V at a high level, for example. The gate threshold voltage of the switching element 41 is approximately 5V, for example. In a case that the display panel 11 comprises approximately 4000 scanning lines, for example, and operates at 120 Hz, the gate control signal has an ON period of approximately two microseconds.

As the display panel 11 is driven with the dot inversion scheme, as shown in the second stage in FIG. 6, the voltage of the source control signal changes to a voltage VH being higher than the common voltage Vcom or a voltage VL being lower than the common voltage Vcom alternately for each scanning of one row. Below, in FIGS. 6 to 9, a case is considered of supplying, to the display cells A and B, the voltage VH of the source control signal being higher than the common voltage Vcom in order to display a white color with a pixel including the display cells A and B in FIG. 5.

With reference to FIG. 6, the capacitor 42 is charged in accordance with the voltage VH of the source control signal over the ON period of the switching element 41. The voltage to be held in the capacitor 42 at the time the ON period of the switching element 41 ends depends on the voltage VH of the source control signal during the ON period and the length of the ON period. In the display cell A, the capacitor 42 is charged and the voltage VH is reached and, thereafter, as seen from the first and second stages in FIG. 6, the source control signal is maintained at the voltage VH as it is until the switching element 41 is turned off (the gate control signal is brought to be at a low level). Therefore, in the display cell A, after the switching element 41 is turned off, as shown in the third stage in FIG. 6, the capacitor 42 holds a desired voltage VH.

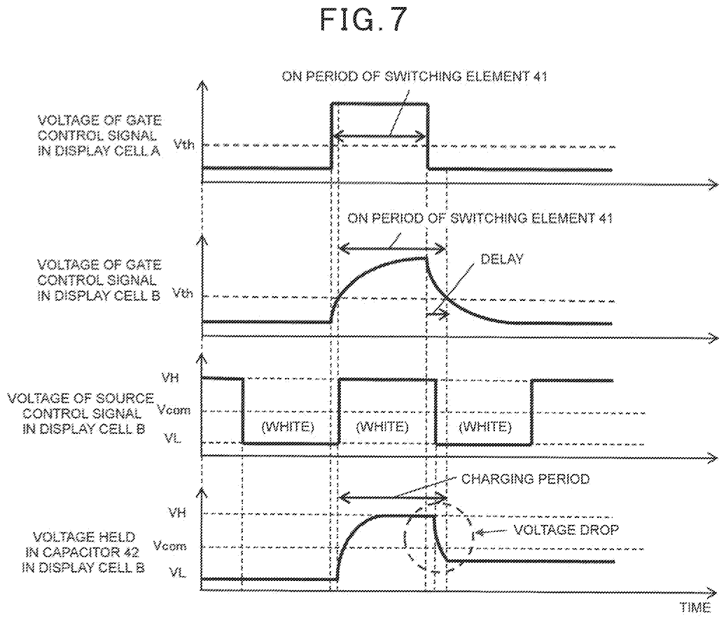

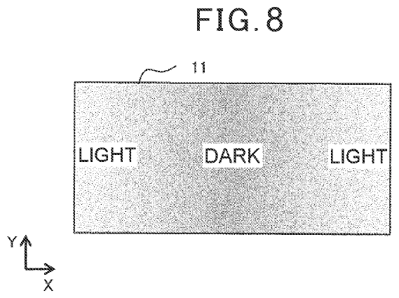

FIG. 7 shows a timing chart of an operation of the display cell 33 when the delay occurs with rounding of a gate control signal in a case of driving the display panel 11 in FIG. 1 with the dot inversion scheme. FIG. 7 shows a case in which each source drive circuit 13 outputs a plurality of source control signals at the same timing. A first stage in FIG. 7 shows the voltage of the gate control signal applied to the gate terminal of the switching element 41 in the display cell A in FIG. 5. A second stage in FIG. 7 shows the voltage of the gate control signal applied to the gate terminal of the switching element 41 in the display cell B in FIG. 5. A third stage in FIG. 7 shows the voltage of the source control signal applied to the drain terminal of the switching element 41 in the display cell B in FIG. 5. A fourth stage in FIG. shows the voltage being held in the capacitor 42 in the display cell B in FIG. 5, FIG. 8 shows the display panel 11 when the delay occurs with rounding of the gate control signal in a case of driving the display panel 11 in FIG. 1 with the dot inversion scheme to display a test image being white as the entire image.

When the gate control signal is transmitted from positions at the left and right sides (for example, the display cell A) to the position at the central portion (for example, the display cell B) of the display panel 11, as shown in the first to the second stages in FIG. 7, rounding occurs in the waveform of the gate control signal due to the resistance R and the capacitance C of the gate signal line 31. The timing at which the switching element 41 is turned on and off is delayed clue to rounding of the waveform of the gate control signal. Therefore, the switching element 41 receives the same effect as in a case that the gate control signal itself is delayed. Here, in a case that (VH-Vth)>(Vth-VL), the fall of the gate control signal is delayed in an amount being greater than the rise of the gate control signal. This causes the ON period of the gate control signal in the display cell B to he longer than the ON period of the gate control signal in the display cell A. Therefore, in a case that each source drive circuit 13 outputs a plurality of source control signals at the same timing, in the display cell B, the time length in which the capacitor 42 is charged (or discharged) in accordance with the voltage of the source control signal is brought to be longer than the time length in the display cell A, causing the timing at which the switching element 41 is turned off to be delayed.

As shown in the second and third stages in FIG. 7, in the display cell B, the source control signal changes from the voltage VH to the voltage VL in the ON period of the switching element 41, and, thereafter, the switching element 41 is turned off. Therefore, in the display cell B, as shown in the fourth stage in FIG. 7, while, in the ON period of the switching element 41, the voltage held in the capacitor 42 rises in accordance with the voltage VH of the source control signal, the voltage held in the capacitor 42 falls in accordance with the voltage VL of the source control signal thereafter. After the switching element 41 is turned off, the capacitor 42 holds a voltage being lower than the voltage VH. In this way, as shown in FIG. 8, luminance at the central portion of the display panel 11 decreases relative to that at the positions in proximity to the left and right sides of the display panel 11.

The voltage to be held in the capacitor 42 of the display cell 33 is determined in accordance with the voltage of the source control signal in a period from when the source control signal supplied to the display cell 33 transitions to a desired voltage VH to when the switching element 41 of the display cell 33 is turned off. Therefore, to hold the voltage VH in the capacitor 42, the source control signal needs to maintain the voltage VH over at least this period. When the voltage of the source control signal transitions from a desired voltage VH of the current display cell 33 to the following voltage VL to be supplied to the display cell 33 of an adjacent row before the switching element 41 is turned off, the voltage being held in the capacitor 42 deviates from the voltage VH to change to the voltage VL, or an intermediate value between the voltage VH and the voltage VL. In this case, even in a case that the display cell 33 is to emit light at the maximum luminance to display white, for example, the voltage being held in the capacitor 42 deviates from the voltage VH and luminance decreases. Moreover, when the tinning at which the source control signal reaches the voltage VH is delayed after the switching element 41 is turned on, the charging time of the capacitor 42 is insufficient, so that the capacitor 42 cannot reach the voltage VH and luminance of the display cell 33 possibly decreases.

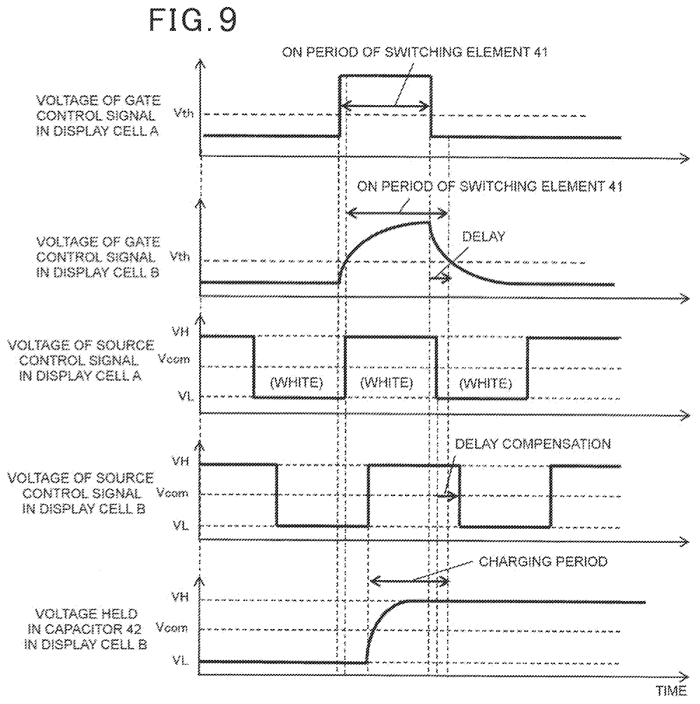

FIG. 9 shows a timing chart showing the operation of the display cell 33 when the source control signal is delayed in accordance with the delay occurring in the gate control signal in a case of driving the display panel 11 in FIG. 1 with the dot inversion scheme. A first stage in FIG. 9 shows a voltage of the gate control signal applied to the gate terminal of the switching element 41 in the display cell A in FIG. 5. A second stage in FIG. 9 shows a voltage of the gate control signal applied to the gate terminal of the switching element 41 in the display cell B in FIG. 5. A third stage in FIG. 9 shows a voltage of the source control signal applied to the drain terminal of the switching element 41 in the display cell A in FIG. 5. A fourth stage iri FIG. 9 shows a voltage of the source control signal applied to the drain terminal of the switching element 41 in the display cell B in FIG. 5. The fifth stage in FIG. 9 shows a voltage being held in the capacitor 42 in the display cell B in FIG. 5.

As shown in the fourth stage in FIG. 9, in the display cell B, the timing at which the source control signal is output by the source drive circuit 13 is delayed at least by a delay amount of the fall of the gate control signal (see the second stage in FIG. 9). In this way, in the display cell B, the source control signal is maintained at the voltage VH as it is until the capacitor 42 is charged to reach the voltage VH and, thereafter, the switching element 41 is turned off. Therefore, in the display cell B, the capacitor 42 holds a desired voltage VH as shown in a fifth stage in FIG. 9 after the switching element 41 is turned off.

As in the following, the arithmetic unit 2 determines the timings at which the source control signals are output for the display cells A and B, respectively.

Each source drive circuit 13 outputs a plurality of source control signals at the same timing in the initial state. Here, a desired voltage VH is held in the capacitor 42 of the display cell A (the third stage in FIG. 6) and a voltage falling from the voltage VH is held in the capacitor 42 of the display cell B (the fourth stage in FIG. 7). Therefore, in the photographed test image, luminance of the display cell B is brought to be lower than luminance of the display cell A.

On the contrary, the arithmetic unit 2 determines the timings at which the source control signals are output for the display cells A and B, respectively, so as to reduce the difference in luminance of the display cells A and B relative to the initial state based on the photographed test image. The arithmetic unit 2 delays the source control signal for the display cell B relative to the source control signal for the display cell A until the difference in luminance of the display cells A and B is reduced, or, preferably, luminances of the display cells A and B match. In this way, the arithmetic unit 2 can determine the delay amount of the source control signal for the display cell B so as to be longer than or equal to the time length from the timing at which the switching element 41 of the display cell A is turned off to the timing at which the switching element 41 of the display cell B is turned off. The delay amount of the source control signal can be determined based on a pre-prepared correspondence table between the luminance difference and the delay amount. As a result, a desired voltage VH is held in the capacitor 42 of the display cell A (the third stage in FIG. 6), and the desired voltage VH is also held in the capacitor 42 of the display cell B (the fifth stage in FIG. 9). Therefore, in the photographed test image, luminances of the display cells A and B match.

When the delay amount of the source control signal for the display cell B is excessive, as described previously, the charging time of the capacitor 42 of the display cell B is not sufficient, so that the voltage of the capacitor 42 cannot reach a desired value and luminance of the display cell B possibly decreases. Therefore, the arithmetic unit 2, based on the photographed test image, determines the timings at which the source control signals are output for the display cells A and B, respectively, to prevent the difference in luminance of the display cells A and B from increasing relative to the initial state and from increasing again from a value to which the difference has been once reduced from the initial state. In this way, the arithmetic unit 2 can determine the delay amount of the source control signal such that the time length in which the switching element 41 of the display cell B is turned on to cause the voltage of the source control signal to be applied to the capacitor 42 of the display cell B is longer or equal to the time length from when the switching element 41 is turned on to when the voltage of the capacitor 42 reaches the voltage of the source control signal.

In the examples in FIGS. 6 to 9, explanations have been given with reference to a case of supplying, to the display cells A and B, the voltage VH of the source control signal being higher than the common voltage Vcom in order to display white. On the other hand, similarly also for a case of supplying, to each of the display cells 33, the voltage VL of the source control signal being lower than the common voltage Vcom in order to display white, the arithmetic unit 2 can determine the timings at which the source control signals are output for the display cells 33, respectively.

In this way, the arithmetic unit 2 determines the delay amount of the source control signal for the display cell included in the target region relative to the source control signal for the display cell included in the reference region so as to reduce the difference in luminance of the target region and the reference region relative to the initial state. By setting the thus determined delay amount of the source control signal in the display apparatus 1, the arithmetic unit 2 can operate the display apparatus 1 as shown in FIG. 9 in a case of driving the display panel 11 with the dot inversion scheme.

In a case of driving the display panel 11 with the horizontal line inversion scheme as well, in the same manner as a case of driving the display panel 11 with the dot inversion scheme, the arithmetic unit 2 can determine the delay amount of the source control signal. With the horizontal line inversion scheme, the polarity of the voltage applied to each of the display cells 33 is inverted for each mutually adjacent gate signal lines 31 (or for each predetermined number of gate signal lines 31), and inverted for each frame. Moreover, with the horizontal line inversion scheme, in the same manner as the dot inversion scheme, the test image has luminance being uniform as the entire image, so that a test image being white as the entire image is used. Moreover, with the horizontal line inversion scheme, the source control signal being the same as that shown in FIG. 9 is supplied to each of the source signal lines 32. In this case as well, the arithmetic unit 2 determines the delay amount of the source control signal for a display cell included in a target region relative to the source control signal for a display cell included in a reference region so as to reduce the difference in luminance of the target region and the reference region relative to the initial state. In a case of driving the display panel 11 with the horizontal line inversion scheme, by setting the thus determined delay amount of the source control signal in the display apparatus 1, the arithmetic unit 2 can operate the display apparatus 1 as shown in FIG. 9 in the same manner as a case of driving the display panel 11 with the dot inversion scheme.

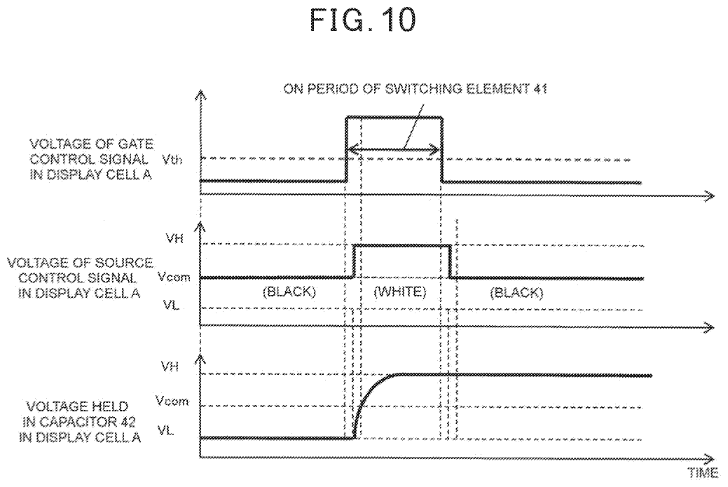

Next, with reference to FIGS. 10 to 13, an operation of the display cell 33, a delay of the gate control signal, and determining of a delay amount of the source control signal in a case of driving the display panel 11 with the vertical line inversion scheme are described.

In a case of driving the display panel 11 with the vertical line inversion scheme as well, in the same manner as in a case of driving the display panel 11 with the dot inversion scheme or the horizontal line inversion scheme, the arithmetic unit 2 can determine the delay amount of the source control signal. In the vertical line inversion scheme, the polarity of the voltage applied to each of the display cells 33 is inverted for each mutually adjacent source signal lines 32 (or each predetermined number of source signal lines 32), and for each frame. Moreover, in the vertical line inversion scheme, a test image has luminance being different for each predetermined number of rows, so that, for example, a black and white stripe image is used. Also in this case, the arithmetic unit 2 determines the delay amount of the source control signal for the display cell included in a target region relative to the source control signal for a display cell included in a reference region so as to reduce the difference in luminance of the target region and the reference region relative to the initial state.

FIG. 10 shows a timing chart of an ideal operation of the display cell 33 in a case of driving the display panel 11 in FIG. 1 with the vertical line inversion scheme. A first stage in FIG. 10 shows the voltage of a gate control signal applied to the gate terminal of the switching element 41 in the display cell A in FIG. 5. A second stage in FIG. 10 shows the voltage of a source control signal applied to the drain terminal of the switching element 41 in the display cell A in FIG. 5. A third stage in FIG. 10 shows the voltage being held in the capacitor 42 in the display cell A in FIG. 5.

The display panel 11 is driven with the vertical line inversion scheme and displays a black and white stripe image, so that, as shown in the second stage of FIG. 10, the voltage of a certain source control signal alternately changes between a common voltage Vcom and a voltage VH for each scanning of one row or n rows (where n is a natural number). Moreover, the voltage of a different source control signal alternately changes between the common voltage Vcom and a voltage VL for each scanning of one row or n rows (where n is a natural number). Whether each source control signal is brought to the voltage VH or the voltage VL switches for each predetermined number of columns and for each frame. Below, in FIGS. 10 to 13, a case is considered of supplying a voltage VH of the source control signal to the display cells A and B in order to display white with pixels including the display cells A and B in FIG. 5, the voltage VH being higher than the common voltage Vcom.

With reference to FIG. 10, as seen from the first to second stages in FIG. 10, in the display cell A, the source control signal is maintained at the voltage VH as it is until the capacitor 42 is charged and the voltage VH is reached and, thereafter, the switching element 41 is turned off (the gate control signal is brought to be at a low level). Therefore, in the display cell A, as shown in the third stage in FIG. 10, the capacitor 42 holds a desired voltage VH after the switching element 41 is turned off.

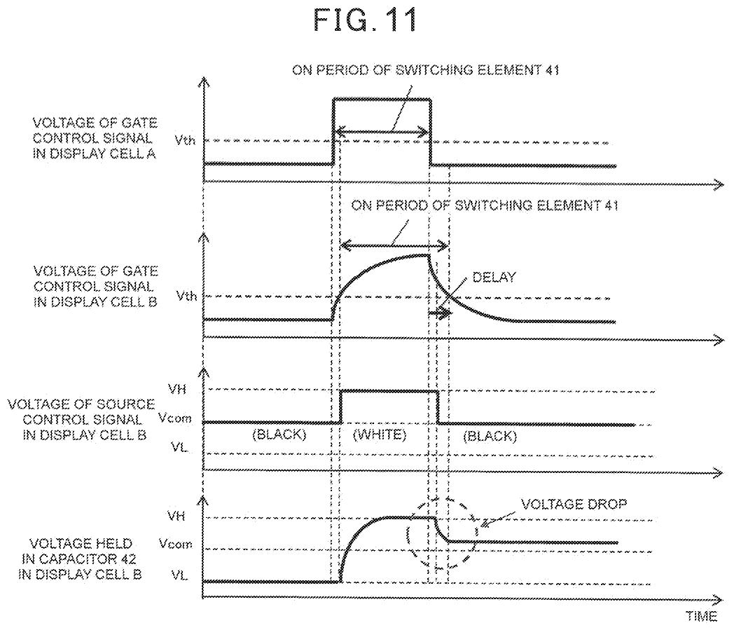

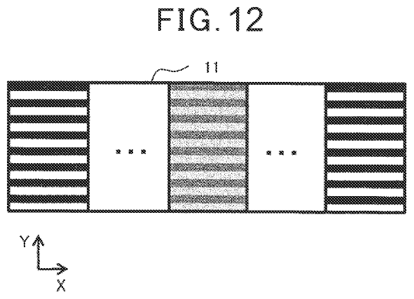

FIG. 11 shows a timing chart of an operation of the display cell 33 when the delay occurs with rounding of the gate control signal in a case of driving the display panel 11 in FIG. 1 with the vertical line inversion scheme. FIG. 11 shows a case in which each of the source drive circuits 13 output a plurality of source control signals at the same timings. A first stage in FIG. 11 shows the voltage of the gate control signal applied to the gate terminal of the switching element 41 in the display cell A in FIG. 5. A second stage in FIG. 11 shows the voltage of the gate control signal applied to the gate terminal of the switching element 41 in the display cell B in FIG. 5. A third stage in FIG. 11 shows the voltage of the source control signal applied to the drain terminal of the switching element 41 in the display cell B in FIG. 5. A fourth stage in FIG. 11 shows the voltage being held in the capacitor 42 in the display cell B in FIG. 5. FIG. 12 shows the display panel 11 when the delay occurs with rounding of the gate control signal in a case of driving the display panel 11 in FIG. 1 with the vertical line inversion scheme to display a black and white stripe image.

As shown in the second to third stages in FIG. 11, in the display cell B, the source control signal changes from the voltage VH to the voltage Vcom in the ON period of the switching element 41 and, thereafter, the switching element 41 is turned off. Therefore, in the display cell B, as shown in the fourth stage in FIG. 11, in the ON period of the switching element 41, the voltage being held in the capacitor 42 rises in accordance with the voltage VH of the source control signal, but, thereafter, falls in accordance with the voltage Vcom of the source control signal. After the switching element 41 is turned off, the capacitor 42 holds a voltage being lower than the voltage VH. In this way, when the voltage of the source control signal transitions to the following voltage Vcom to be supplied to the display cell 33 of an adjacent row from a desired voltage VH of the current display cell 33 before the switching element 41 is turned off, the voltage being held in the capacitor 42 deviates from the voltage VH to change to the voltage Vcom or to an intermediate value of the voltage VH and the voltage Vcom. Therefore, even in a case that the capacitor 42 is to hold the voltage VH for the pixel including the display cell 33 to display white (to be brought to have the maximum luminance), the voltage being held in the capacitor 42 is brought to be lower than the voltage VH.

Similarly, when the voltage of the source control signal transitions to the following voltage VH to be supplied to the display cell 33 of an adjacent row from a desired voltage Vcom of the current display cell 33 before the switching element 41 is turned off, the voltage being held in the capacitor 42 deviates from the voltage Vcom to change to the voltage VH or to an intermediate value between the voltage Vcom and the voltage VH. Therefore, even in a case in which the capacitor 42 is to hold the voltage Vcom for the pixel including the display cell 33 to display black (in other words, to be brought to have the minimum luminance), the voltage being held in the capacitor 42 is brought to be higher than the voltage Vcom.

In this way, in a case of attempting to display a stripe image in which black and white alternate for each row, the display cell 33 of the pixel to display white is brought to be darker than the maximum luminance, while the display cell 33 of the pixel to display black is brought to be lighter than the minimum luminance, causing ghost to be generated and the edge of the image to be blurred. Moreover, for example, as shown in FIG. 12, contrast in the vicinity of the central portion of the display panel 11 decreases relative to the positions in proximity to left and right sides of the display panel 11.

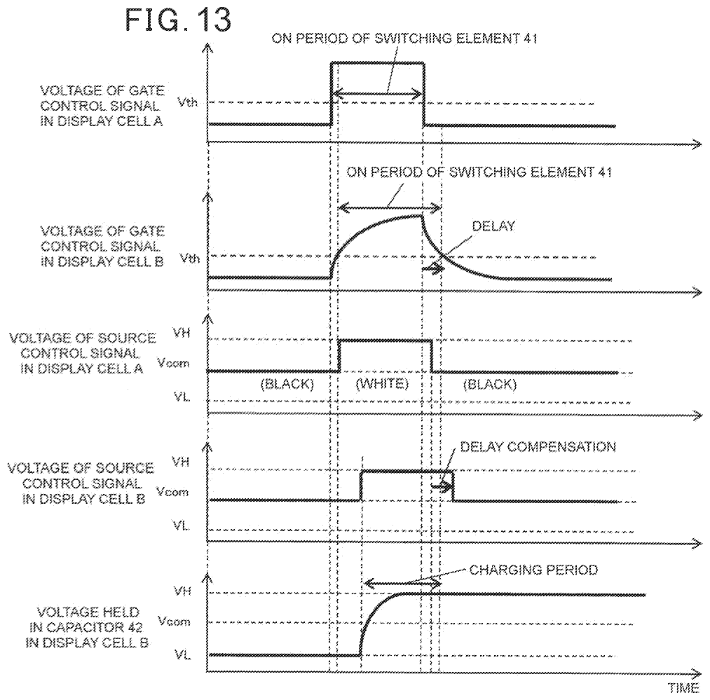

FIG. 13 shows a timing chart of the operation of the display cell 33 when a source control signal is delayed in accordance with a delay occurring in a gate control signal in a case of driving the display panel 11 in FIG. 1 with the vertical line inversion scheme. A first stage in FIG. 13 shows the voltage of the gate control signal applied to the gate terminal of the switching element 41 in the display cell A in FIG. 5. A second stage in FIG. 13 shows the voltage of the gate control signal applied to the gate terminal of the switching element 41 in the display cell B in FIG. 5. A third stage in FIG. 13 shows the voltage of the source control signal applied to the drain terminal of the switching element 41 in the display cell A in FIG. 5. A fourth stage in FIG. 13 shows the voltage of the source control signal applied to the drain terminal of the switching element 41 in the display cell B in FIG. 5. A fifth stage in FIG. 13 shows the voltage being held in the capacitor 42 in the display cell B in FIG. 5.

As shown in the fourth stage in FIG. 13, in the display cell B, the timing at which the source control signal is output by the source drive circuit 13 is delayed at least by a delay amount of the fall of the gate control signal (see the second stage in FIG. 13). In this way, in the display cell B, the capacitor 42 is charged to reach the voltage VH and, until the switching element 41 is turned off thereafter, the source control signal is maintained at the voltage VH as it is. Therefore, in the display cell B, after the switching element 41 is turned off, as shown in the fifth stage in FIG. 13, the capacitor 42 holds a desired voltage VH.

As in the following, the arithmetic unit 2 determines the timings at which the source control signals are output for the display cells A and B, respectively.

Each source drive unit 13 outputs a plurality of source control signals at the same timings in the initial state. Here, a desired voltage VH is held in the capacitor 42 of the display cell A (the third stage in FIG. 10) and a voltage after falling from the voltage VH is held in the capacitor 42 of the display cell B (the fourth stage in FIG. 11). Moreover, a desired voltage Vcom is held in the capacitor 42 of the display cell 33 being connected to the same source signed line 32 as the display cell A and being adjacent to the display cell A. Furthermore, a voltage after rising from the voltage Vcom is held in the capacitor 42 of the display cell 33 being connected to the same source signal line 32 as the display cell B and being adjacent to the display cell B. Therefore, in the photographed test image, the luminance contrast in a region in proximity to the display cell B is brought to be lower than the luminance contrast in a region in proximity to the display cell A.

On the contrary, the arithmetic unit 2 determines the timings at which the source control signals are output for the display cells A and B, respectively, so as to reduce the difference in the luminance contrast between the regions in proximity to the display cells A and B relative to the initial state, based on the photographed test image. The arithmetic unit 2 delays the source control signal for the display cell B relative to the source control signed for the display cell A until the difference in the luminance contrast between the regions in proximity to the display cells A and B is reduced, or, preferably, the luminance contrasts in the regions in proximity to the display cells A and B match. In this way, the arithmetic unit 2 can determine the delay amount of the source control signal for the display cell B so as to be longer than or equal to the time length from the timing at which the switching element 41 of the display cell A is turned off to the timing at which the switching element 41 of the display cell B is turned off. As a result, a desired voltage VH is held in the capacitor 42 of the display cell A (the third stage in FIG. 10) and a desired voltage VH is held also in the capacitor 42 of the display cell B (the fifth stage in FIG. 13). Similarly, a desired voltage Vcom is held in the capacitor 42 of the display cell 33 being connected to the same source signal line 32 as the display cell A and being adjacent to the display cell A. Moreover, a desired voltage Vcom is held also in the capacitor 42 of the display cell 33 being connected to the same source signal line 32 as the display cell B and being adjacent to the display cell B. Therefore, in the photographed test image, the luminance contrasts in the regions in proximity to the display cells A and B match.

When the delay amount of the source control signal for the display cell B is excessive, the charging time of the capacitor 42 of the display cell B is insufficient, so that the voltage of the capacitor 42 cannot reach a desired value and the luminance contrast in the region in proximity to the display cell B possibly decreases. Therefore, the arithmetic unit 2, based on the photographed test image, determines the timings at which the source control signals are output for the display cells A and B, respectively, so as to prevent the difference in luminance contrast in the regions in proximity to the display cells A and B from increasing relative to the initial state and from increasing again from a value to which the difference has been once reduced relative to the initial state. In this way, the arithmetic unit 2 determines the delay amount of the source control signal such that the time length in which the switching element 41 is turned on to cause the voltage of the source control signal to be applied to the capacitor 42 of the display cell B is longer or equal to the time length from when the switching element 41 is turned on to when the voltage of the capacitor 42 reaches the voltage of the source control signal.

In the examples in FIGS. 10 to 13, a case is referred to of supplying, to the display cells A and B, the voltage VH of the source control signal being higher than the common voltage Vcom in order to display white. On the other hand, also in the same manner for a case of supplying, to each of the display cells 33, the voltage VL of the source control signal being lower than the common voltage Worn in order to display white, the arithmetic unit 2 can determine the timings at which the source control signals are output for the display cells 33, respectively.

In this way, the arithmetic unit 2 determines the delay amount of the source control signal for the display cell included in the target region relative to the source control signal for the display cell included in the reference region such that the difference in the luminance contrast of two mutually adjacent rows in the target region with respect to the luminance contrast of two mutually adjacent rows in the reference region is reduced relative to the initial state. By setting the thus determined delay amount of the source control signal in the display apparatus 1, the arithmetic unit 2 can operate the display apparatus 1 as shown in FIG. 13 in a case of driving the display panel 11 with the vertical line inversion scheme.

To measure the luminance contrast of two mutually adjacent rows, the photographing apparatus 3 can comprise a high resolution photographing element that can measure luminance of an individual row, for example. Moreover, the photographing apparatus 3 can comprise optics such as a magnifying lens or a close-up lens, the optics being mounted to the photographing apparatus 3, and a drive mechanism to move the photographing apparatus 3 itself across the screen of the display panel 11. Furthermore, the calibration apparatus can comprise at least three photographing apparatuses being provided in proximity to the left side, in proximity to the right side, and at the central portion, respectively, on the display panel 11, and optics such as a magnifying lens or a close-up lens, the optics being mounted to each of the photographing apparatuses.

The arithmetic unit 2 determines the delay amount of the source control signal so as to be longer than or equal to the time length from the timing at which the switching element 41 of the display cell 33 included in the reference region is turned off to the timing at which the switching element 41 of the display cell 33 comprises in the target region is turned off. Moreover, the arithmetic unit 2 determines the delay amount of the source control signal such that the time length in which the switching element 41 of the display cell 33 included in the target region is turned on to cause the voltage of the source control signal to be applied to the capacitor 42 of the display cell 33 is longer than or equal to the time length from when the switching element 41 is turned on to when the voltage of the capacitor 42 reaches the voltage of the source control signal. In this way, even when the source control signal is delayed, the time length being sufficient for the voltage of the capacitor 42 to reach the voltage of the source control signal is secured, thus making an occurrence of a decrease in luminance caused by delaying the source control signal unlikely.

FIG. 14 shows a flowchart of a calibration process to be executed by the arithmetic unit 2 in FIG. 1. In step S1, the central processing unit 22 of the arithmetic unit 2 reads a test image (for example, a white image or a stripe image) from the hard disk drive 24, sends the test image to the display apparatus 1, and cause the display panel 11 to display the test image. In step S2, using the photographing apparatus 3, the central processing unit 22 photographs the test image being displayed on the display panel 11. In step S3, based on the photographed test image, the central processing unit 22 determines a delay amount of the source control signal as described with reference to FIGS. 6 to 13. In step S4, the central processing unit 22 determines whether the difference in luminance or contrast in the entire test image photographed is smaller than a predetermined threshold value, and, if YES, the process proceeds to step S5, and, if NO, the process returns to step S2. In step S5, the central processing unit 22 sends the delay amount of the source control signal to the display apparatus 1, causing the memory 15 to save it therein. In this way, the arithmetic unit 1 makes it possible to calibrate the display apparatus 1 so as to reduce variations in luminance.

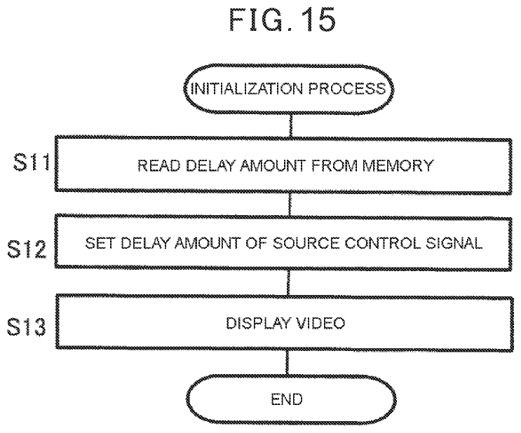

FIG. 15 shows a flowchart of an initialization process to be executed by the display apparatus 1 in FIG. 1. The initialization process in FIG. 15 is executed when the power of the display apparatus 1 is tuned on, for example. In step S11, the control circuit 14 of the display apparatus 1 reads the delay amount of the source control signal determined by the arithmetic unit 2 from the memory 15. In step S12, the control circuit 14 sets the delay amount of the source control signal to each source drive circuit 13. In step S13, the control circuit 14 displays a video. In this way, the display apparatus 1 can display the video being calibrated so as to reduce variations in luminance.

According to the first embodiment, by setting the delay amount of the source control signal based on the test image that is displayed on the display panel 11 and photographed by the photographing apparatus 3, it is possible to calibrate the display apparatus 1 so as to reduce variations in luminance.

As described previously, when rounding of the waveform of the gate control signal occurs, the timing at which the switching element 41 is turned on and/or off is delayed. According to the first embodiment, the delay amount of the source control signal can be determined in consideration for such a delay so as to overcome a decrease in luminance.

The first embodiment can also be applied in the same manner to a case in which the gate drive circuit 12 is provided at only the left side or the right side of the display panel 11. Moreover, the first embodiment can also be applied inn the same mariner to a case in which the source drive circuits 13 are provided at both the upper and lower sides of the display panel 11.

### Second Embodiment

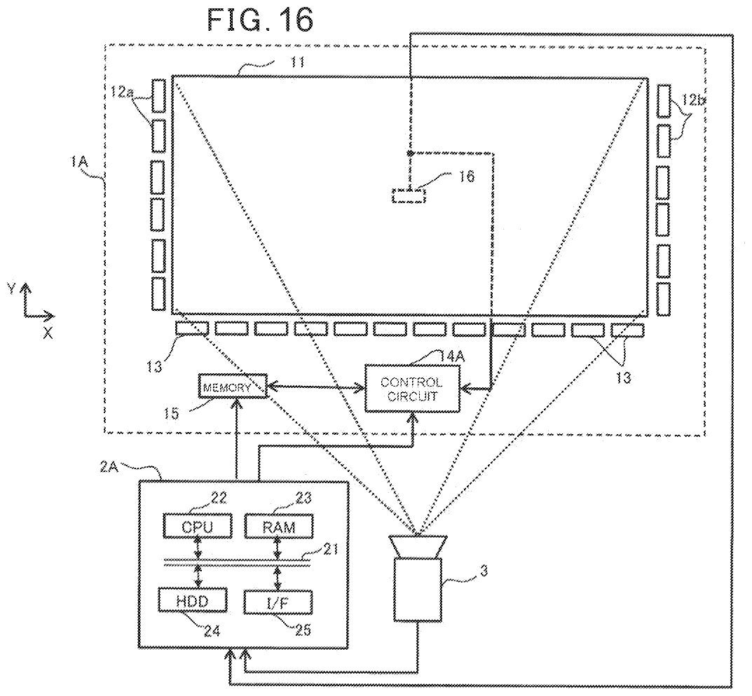

FIG. 16 shows a block diagram of the configuration of a display apparatus 1A, an arithmetic unit 2A, and a photographing apparatus 3 according to a second embodiment. The display apparatus 1A in FIG. 16 comprises a control circuit 14A in replacement of the control circuit 14 of the display apparatus 1 in FIG. 1 and, moreover, comprises a temperature sensor 16 to measure the temperature of the display panel 11. The temperature of the display panel 11 being measured by the temperature sensor 16 is sent to the control circuit 14A and the arithmetic unit 2A. The arithmetic unit 2A sets different delay amounts of the source control signal in accordance with different temperatures of the display panel 11.

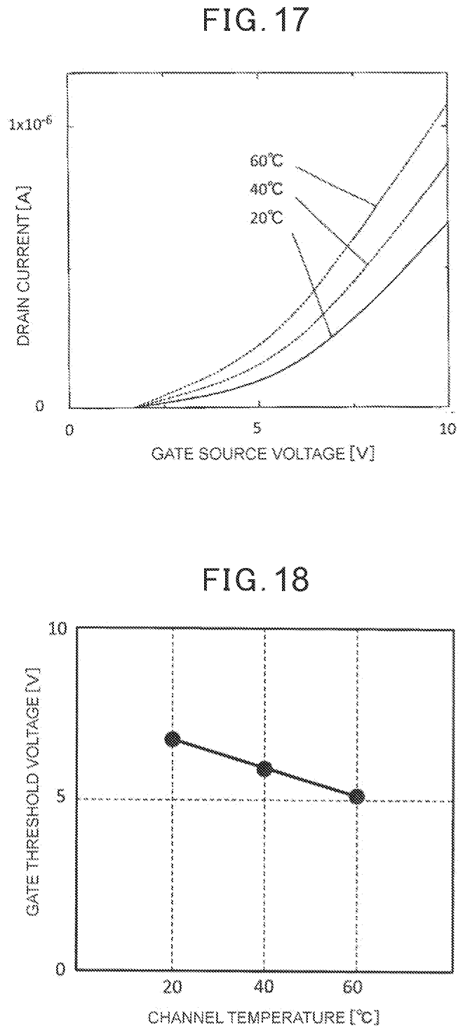

FIG. 17 shows a graph of the drain current characteristics with respect to the gate-source voltage for each switching element 41 of the display panel 11 in FIG. 16. FIG. 18 shows a graph of the gate threshold voltage characteristics with respect to the channel temperature for each switching element 41 of the display panel 11 in FIG. 16. Various characteristics of the switching element 41 change in accordance with temperature, so that, even when rounding of the waveform of the gate control signal is the same, the timing at which the switching element 41 is turned on and off changes in accordance with temperature. Therefore, by the arithmetic unit 2A predetermining different delay amounts of the source control signal in accordance with different temperatures to save the predetermined delay amount in the memory 15, the display apparatus 1A can make it unlikely for variations in luminance to occur even when the temperature of the display panel 11 varies.

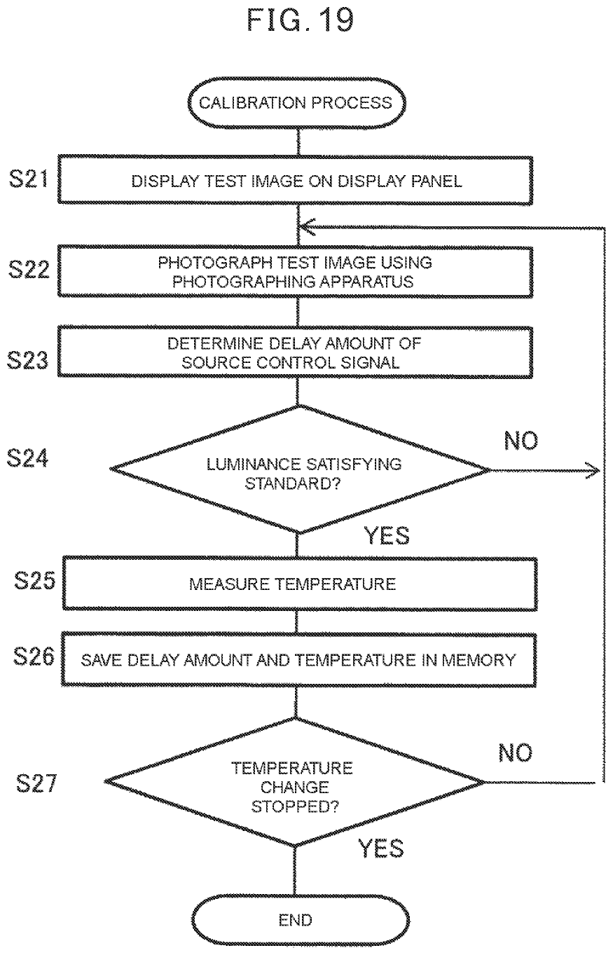

FIG. 19 shows a flowchart of the calibration process to be executed by the arithmetic unit 2A in FIG. 16. Steps S21 to S24 in FIG. 19 are similar to the steps S1 to S4 in FIG. 14. In step S25, the central processing unit 22 of the arithmetic unit 2A measures the temperature of the display panel 11 using the temperature sensor 16. In step S26, the central processing unit 22 sends the delay amount of the source control signal and the temperature of the display panel 11 to the display apparatus 1 and causes the memory 15 to save them therein. In step S27, the central processing unit 22 determines whether the temperature change stopped and, if YES, the process is terminated, and, if NO, the process returns to step S22. The central processing unit 22 can determine that the temperature change stopped when the change amount of the temperature is less than or equal to a predetermined threshold in the time period of a predetermined length, for example. In this way, the arithmetic unit 2A can determine the different delay amounts of the source control signal in accordance with different temperatures.

FIG. 19 shows the operation from when the power of the display apparatus 1A is turned on to when the temperature of the display panel 11 reaches the steady state. In replacement thereof, the different delay amounts of the source control can be determined in accordance with different temperatures of the display panel 11 while heating the display panel 11 using a heating apparatus.

The arithmetic unit 2A can determine the delay amount in a temperature other than the measured temperature by an operation such as interpolation or extrapolation based on a number of sets of delay amounts and temperatures being determined by the calibration process in FIG. 19, and can save the determined delay amount in the memory 15.

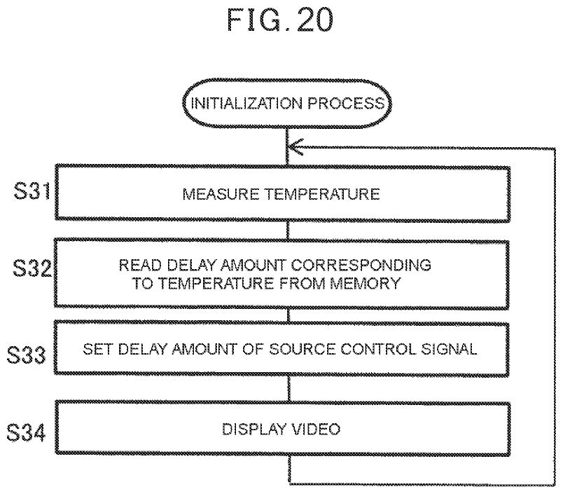

FIG. 20 shows a flowchart of the initialization process to be executed by the display apparatus 1A in FIG. 16. In step S31, the control circuit 14A of the display apparatus 1A measures the temperature of the display panel 11 using the temperature sensor 16. In step S32, the control circuit 14A reads, from the memory 15, the delay amount of the source control signal corresponding to temperature. Steps S33 to S34 in FIG. 20 are similar to the steps S2 to S3 in FIG. 15. Thereafter, the process returns to step S31 and, if the temperature changes, the process is repeated.

According to the second embodiment, by pre-determining different delay amounts of the source control signal in accordance with different temperatures, the display apparatus 1A can display a video being calibrated so as to reduce variations in luminance without having to recalibrate the display apparatus 1A using the photographic apparatus 3 even when the temperature of the display panel 11 changes.

When the temperature measured using the temperature sensor 16 is different from the temperature saved in the memory 15, the control circuit 14A can read the delay amount corresponding to a temperature closest to the measured temperature from the memory 15 and set the read delay amount to each source drive circuit 13. In replacement thereof, the control circuit 14A can interpolate the delay amount based on the measured temperature and set the interpolated delay amount to each source drive circuit 13 if the delay amount changes almost linearly in accordance with the temperature.

[Method of Setting Delay Amount]

Next, a specific method to set, to the display apparatus 1, the delay amount of the source control signal being determined by the arithmetic unit 2 is described.

In a display panel having a large size such as 70 to 80 inches, the delay amount of the source control signal being determined by the arithmetic unit 2 can reach a maximum of greater than or equal to approximately one microsecond.

Moreover, in a high resolution display apparatus such as Hi vision (FHD), 4K, or 8K, for example, a very large number of source signal lines are provided at predetermined intervals in the horizontal direction of the display panel, so that not all of the source control signals to be supplied to the display panel can be generated in an integrated circuit of a single source drive circuit. In this case, the source control signals are generated using the integrated circuit of a plurality of source drive circuits being mutually juxtaposed to drive the display panel. Therefore, the plurality of source drive circuits needs to be controlled individually and in mutual cooperation.

Below, a method is described of controlling a plurality of source drive circuits 13 so as to satisfy these conditions and supplying a plurality of source control signals to each of the display cells 33 with a delay amount being determined by the arithmetic unit 2.

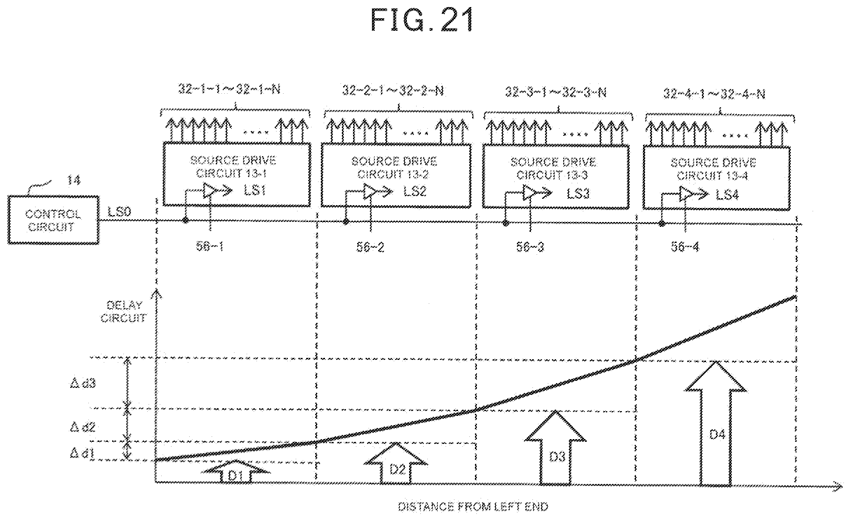

FIG. 21 shows a diagram to explain a method to set a delay amount of a source control signal in the display apparatus 1 in FIG. 1. FIG. 21 only shows a control circuit 14 and four source drive circuits 13-1 to 13-4 of constituting elements of the display apparatus 1 in FIG. 1, so that other constituting elements are omitted for brevity of explanations. Each one source drive circuit of the source drive circuits 13-1 to 13-4 is connected to a plurality of mutually adjacent source lines 32-m-n, the plurality being N (where 1≤m≤4, 1≤n≤N). The control circuit 14 supplies, to each of the source drive circuits 13-1 to 13-4, a latch pulse signal LS0 to cause each of the source control signals to be output from an internal buffer of each of the source drive circuits 13-1 to 13-4. In the specification, the latch pulse signal LS0 is also called “a third control signal”.

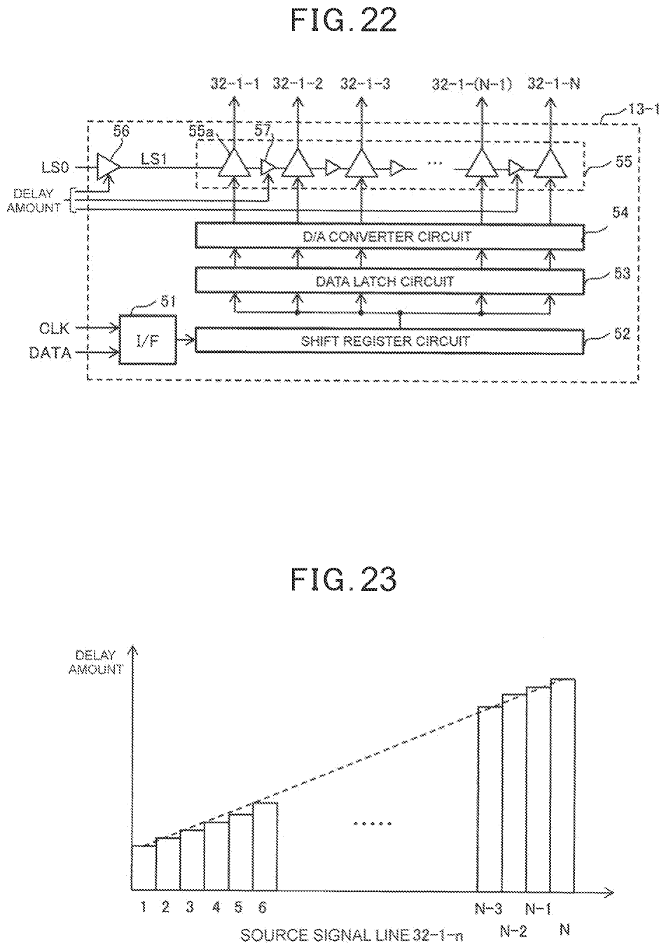

FIG. 22 shows a block diagram of the detailed configuration of the source drive circuit 13-1 in FIG. 21. The source drive circuit 13-1 comprises an interface (I/F) 51, a shift register circuit 52, a data latch circuit 53, a D/A converter circuit 54, an output buffer circuit 55, and delay circuits 56, 57. The source drive circuit 13-1 receives, from the control circuit 14, a clock signal CLK, a data signal DATA indicating the grayscale of each pixel of an image along one row, a delay amount of a source control signal read from a memory 15, and a latch pulse signal LS0. The clock signal CLK and the data signal DATA are serial data indicating a video.

The interface (I/F) 51 receives a clock signal CLK and a data signal DATA sent from the control circuit 14 and stores the received data in the shift register circuit 52. The shift register circuit 52 sends the stored data for each specified amount of data to the data latch circuit 53 and causes the sent data to be stores as N channel parallel data. The data latch circuit 53 sends N channel parallel data (digital data) stored to the D/A converter circuit 54. The D/A converter circuit 54 digital-analog converts the N channel parallel data sent from the data latch circuit 53 to N channel voltage values and sends the converted N channel voltage values to the output buffer circuit 55. The output buffer circuit 55 comprises N buffers 55a and each of the voltage values sent from the D/A converter circuit 54 is stored in each of the buffers 55a.

When a latch pulse signal is input to each of the buffers 55a of the output buffer circuit 55, each of the buffers 55a outputs, to the source signal lines 32-1-1 to 32-1-N, a voltage value being stored inside as a source control signal at the timing of a rise of the latch pulse signal, for example. Here, a latch pulse signal being the latch pulse signal LS0 delayed by the delay circuits 56, 57 is input to each of the buffers 55a. The delay circuit 56 delays the latch pulse signal LS0 with the delay amount D1 of the first delay amounts D1 to D4 being different for each of the source drive circuits 13-1 to 13-4. The latch pulse signal LS0 being delayed by the delay circuit 56 is called “a latch pulse signal LS1”. The delay circuit 57 delays the latch pulse signal LS1 with a second delay amount being different for each of the source signal lines 32-1-1 to 32-1-N being connected to the source drive circuit 13-1. In the specification, the delay circuit 56 is also called “a first delay circuit”, while the delay circuit 57 is also called “a second delay circuit”. In the source drive circuit according to the prior art, all of the buffers 55a generally respond to one latch pulse signal to output the source control signal at the same time. On the other hand, in the source drive circuit 13-1 according to an embodiment, by shifting the phase of a latch pulse signal for each of the buffers 55a, it is possible to set various delay amounts to a plurality of source control signals to be output by the one source drive circuit 13-1.

The first and second delay amounts are determined by the arithmetic unit 2 to be saved in the memory 15 and read from the memory 15 by the control circuit 14 to be set in the delay circuits 56, 57. The arithmetic unit 2 determines the first delay amount D1 based on each average value of luminances in each partial region, in the test image, corresponding to the source drive circuit 13-1. Moreover, the arithmetic unit 2 determines the second delay amount based on a value Δd0=Δd1/N obtained by dividing the difference Δd1=D2-D1 in the first delay amount of two mutually adjacent source drive circuits 13-1, 13-2 by the number N of the source signal lines 32-1-1 to 32-1-N being connected to the one second drive circuit 13-1. The arithmetic unit 2 determines the second delay amount of the source control signal to be supplied to each of the display cells 33, for example, so as to increase by a value Δd0 as the distance of the display cell 33 from the gate drive circuit 12 increases, for example. In this way, the arithmetic unit 2 can determine the first and second delay amounts such that the sum of the first and second delay amounts is equal to a desired delay amount of each source control signal.

FIG. 23 shows a graph of a delay amount to be set to the source control signal transmitted via each of the source signal lines 32-1-1 to 32-1-N in FIG. 22. The delay amount of the source signal line 32-1-1 has the minimum value in the source drive circuit 13-1 and is equal to the first delay amount D1 of the source drive circuit 13-1. Moreover, the delay amount of the source signal line 32-1-N has the maximum value in the source drive circuit 13-1 and is substantially equal to the first delay amount D2 of the source drive circuit 13-2. The delay amount of the other source signal lines 32-1-2 to 32-1-(N-1) linearly increases from the delay amount D1 to the delay amount D2.

The delay circuits 56, 57 can delay the latch pulse signal LS0 analogically, or can delay it digitally based on a clock faster than the latch pulse signal LS0. The digital delay circuit can delay the latch pulse signal LS0 more precisely than the analog delay circuit.

The latch pulse signal LS0 can be generated by the source drive circuit 13-1 based on the clock signal CLK and the data signal DATA instead of being input to the source drive circuit 13-1 from the control circuit 14 separately from the clock signal CLK and the data signal DATA.

The source drive circuits 13-2 to 13-4 are also configured in the same manner as the source drive circuit 13-1.

Again with reference to FIG. 21, the source drive circuits 13-1 to 13-4 comprise delay circuits 56-1 to 56-4, respectively. The delay circuits 56-1 to 56-4 correspond to the delay circuit 56 in FIG. 22, and delay the latch pulse signal LS0 with first delay amounts D1 to D4 being different for each of the source drive circuits 13-1 to 13-4 and generates delayed latch pulse signals LS1 to LS4. The delay amounts being set to the source control signals transmitted via the source signal line 32-1-N at the right end of the source drive circuit 13-1 and the source signal line 32-1-1 at the left end of the source drive circuit 13-2, respectively, are substantially equal to each other. In the same manner, the delay amounts being set to the source control signals each transmitted via a pair of mutually adjacent source signal lines at each border of the source drive circuits 13-2 to 13-4 are substantially equal to each other. In this way, even when the plurality of source drive circuits 13-1 to 13-4 are used, the delay amount can be changed substantially continuously, so that a drastic change of the delay amount in between the mutually adjacent source drive units can be made unlikely to occur, and it is possible to suppress a sharp change in luminance.

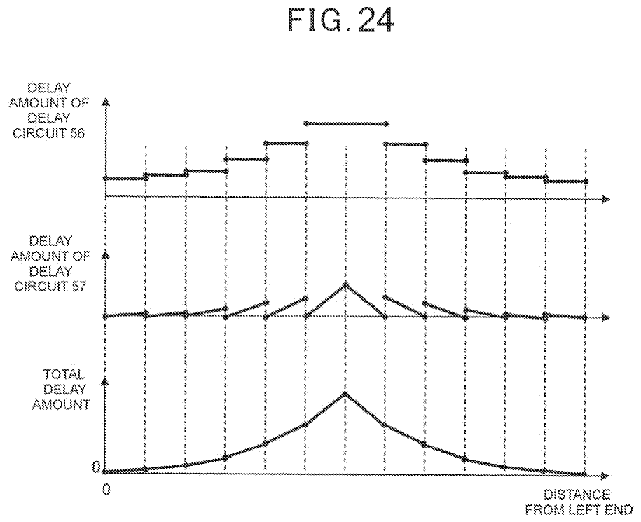

FIG. 24 shows a graph of synthesis of the delay amounts in each of the source drive circuits 13 in FIG. 1. Even in a case of a large-sized and high-resolution display apparatus 1 in which a large delay amount needs to be set for the source control signal, the delay amounts of the delay circuits 56, 57 can be synthesized to set a desired delay amount for the source control signal so as to reduce variations in luminance. Moreover, as described in the above, a plurality of source drive circuits 13 can be controlled individually and in mutual cooperation to generate a source control signal and drive a display panel 11.

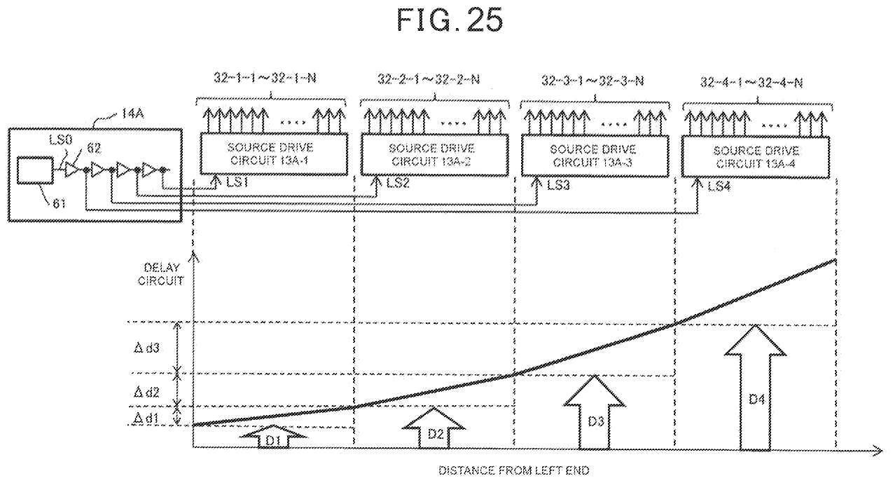

FIG. 25 shows a diagram to explain a method to set a delay amount of a source control signal in the display apparatus according to a variation of the first embodiment. FIG. 25 shows a case in which the display apparatus 1 in FIG. 1 comprises source drive circuits 13A-1 to 13A-4 and a control circuit 14A in replacement of the source drive circuits 13-1 to 13-4 and the control circuit 14 in FIG. 21.

The source drive circuits 13A-1 to 13A-4 have the configuration in which the delay circuits 56-1 to 56-4 are removed from the source drive circuits 13-1 to 13-4 in FIG. 21. In the same manner as the source drive circuit 13-1 in FIG. 22, each one source drive circuit of the source drive circuits 13A-1 to 13A-4 comprises the delay circuit 57 (a second delay circuit) to delay the latch pulse signal LS0 with a second delay amount being different for each of the source signal lines 32 being connected to the relevant source drive circuit.

The control circuit 14A comprises a latch signal generator 61 and a delay circuit 62. The latch signal generator 61 is a signal source to generate the latch pulse signal LS0 to cause each of the source control signals to be output. In the same manner as the delay circuits 56-1 to 56-4 in FIG. 21, the delay circuit 62 delays the latch pulse signal LS0 with first delay amounts D1 to D4 being different for each of the source drive circuits 13A-1 to 13A-4 and generates the delayed latch pulse signals LS1 to LS4. The latch pulse signals LS1 to LS4 are supplied to each of the source drive circuits 13A-1 to 13A-4. In the specification, the delay circuit 62 is also called “a first delay circuit”.

In the case of FIG. 25 as well, in the same manner as in the case of FIG. 21, the first and second delay amounts are determined by the arithmetic unit 2 to be saved in the memory 15, and read from the memory 15 by the control circuit 14A to be set in the delay circuits 62, 57. The arithmetic unit 2 determines the first and second delay amounts such that a sum of the first and second delay amounts is equal to a desired delay amount of each of the source control signals.

The method to set the delay amount being described. with reference to FIGS. 21 to 25 is not limited to a case of setting the delay amount being determined based on the test image being displayed on the display panel 11 and photographed by the photographing apparatus 3, so that it can be applied to a case of setting a different arbitrary delay amount to the source drive circuit 13.

### INDUSTRIAL APPLICABILITY

The invention can be utilized in a case of calibrating so as to reduce variations in luminance in a large-sized and high-resolution display apparatus.

### DESCRIPTION OF REFERENCE NUMERALS

1, 1A DISPLAY APPARATUS

2, 2A ARITHMETIC UNIT

3 PHOTOGRAPHING APPARATUS

11 DISPLAY PANEL

12a, 12b GATE DRIVE CIRCUIT

13, 13-1 to 13-4, 13A-1 to 13A-4 SOURCE DRIVE CIRCUIT

14, 14A CONTROL CIRCUIT

15 MEMORY

16 TEMPERATURE SENSOR

21 BUS

22 CENTRAL PROCESSING UNIT (CPU)

23 RANDOM ACCESS MEMORY (RAM)

24 HARD DISK DRIVE (HDD)

25 INTERFACE (I/F)

31 GATE SIGNAL LINE

32 SOURCE SIGNAL LINE

33 DISPLAY CELL

41 SWITCHING ELEMENT

49 CAPACITOR

43 DISPLAY ELEMENT

51 INTERFACE(I/F)

52 SHIFT REGISTER CIRCUIT

53 DATA LATCH CIRCUIT

54 D/A CONVERTER CIRCUIT

55 OUTPUT BUFFER CIRCUIT

55a BUFFER

56, 56-1 to 56-4, 57 DELAY CIRCUIT

61 LATCH SIGNAL GENERATOR

62 DELAY CIRCUIT

1. A calibration apparatus to calibrate a display apparatus, wherein
the display apparatus comprises a display panel comprising a plurality of first signal lines along a plurality of rows, a plurality of second signal lines along a plurality of columns, and a plurality of display cells each being connected to one of the plurality of first signal lines and one of the plurality of second signal lines wherein the plurality of display cells is selected for each of the rows by a plurality of first control signals applied via the plurality of first signal lines, and wherein the plurality of display cells displays an image in accordance with a plurality of second control signals applied via the plurality of second signal lines, the plurality of second control signals indicating a grayscale of the plurality of display cells, and
the calibration apparatus comprising:
a photographing apparatus to photograph a screen of the display panel; and
an arithmetic unit to:
cause the display panel to display a test image; and
set a delay amount of the second control signal for the display cell included in a second region relative to the second control signal for the display cell included in a first region such that luminance of the second region satisfies a predetermined standard with respect to luminance of the first region, based on luminances of the first region and the second region of a test image that is displayed on the display panel and photographed by the photographic apparatus.

2. The calibration apparatus according to claim 1, wherein
the display panel is driven with a dot inversion scheme in which a voltage having a polarity to be inverted for each of the rows, for each of the columns, and for each frame is applied to each display cell, or with a line inversion scheme in which a voltage having a polarity to be inverted for each predetermined number of rows and for each frame is applied to each display cell;
the test image has uniform luminance as the entire image; and
the arithmetic unit sets a delay amount of the second control signal for the display cell included in the second region relative to the second control signal for the display cell included in the first region so as to reduce the difference in luminance of the second region and the first region relative to an initial state.

3. The calibration apparatus according to claim 1, wherein
the display panel is driven with a line inversion scheme in which a voltage having a polarity to be inverted for each predetermined number of columns and for each frame is applied to each display cell;
the test image has different luminance for each predetermined number of rows; and
the arithmetic unit sets a delay amount of the second control signal for the display cell included in the second region relative to the second control signal for the display cell included in the first region such that the difference in luminance contrast of two mutually adjacent rows in the second region with respect to luminance contrast of two mutually adjacent rows in the first region is reduced relative to an initial state.

4. The calibration apparatus according to claim 1, wherein
each of the display cells comprises a switching element to be turned on and off in accordance with the first control signal and a capacitive element being connected to the second signal line via the switching element; and
the arithmetic unit
sets the delay amount so as to be longer than or equal to a time length from a timing at which a switching element of the display cell included in the first region is turned off to a timing at which a switching element of the display cell included in the second region is turned off, and
sets the delay amount such that a time length in which a switching element of the display cell included in the second region is turned on and a voltage of the second control signal is applied to the capacitive element of the display cell is longer than or equal to a time length from when the switching element is turned on to when a voltage of the capacitive element reaches a voltage of the second control signal.

5. The calibration apparatus according to claim 1, wherein
the display apparatus further comprises a temperature sensor to measure a temperature of the display panel; and
the arithmetic unit sets a different delay amount in accordance with a different temperature of the display panel.

6. The calibration apparatus according to claim 1, wherein
the display apparatus further comprises:
at least one first drive circuit to supply the plurality of first control signals via the plurality of first signal lines to the plurality of display cells;
a plurality of second drive circuits to supply the plurality of second control signals via the plurality of second signal lines to the plurality of display cells; and
a control circuit to control the first and second drive circuits, wherein
each one second drive circuit of the plurality of second drive circuits is connected to a plurality of mutually adjacent signal lines of the plurality of second signal lines;
the control circuit comprises a signal source to supply, to each of the second drive circuits, a third control signal to cause each of the second control signals to be output;
each one second drive circuit of the plurality of second drive circuits comprises:
a first delay circuit to delay the third control signal with a first delay amount different for each of the second drive circuits, and
a second delay circuit to delay the third control signal with a second delay amount different for each of the second signal lines being connected to a relevant one second drive circuit; and
the arithmetic unit sets the first and second delay amounts such that the delay amount of each of the second control signals is equal to a sum of the first and second delay amounts.

7. The calibration apparatus according to claim 1, wherein
the display apparatus further comprises:
at least one first drive circuit to supply the plurality of first control signals via the plurality of first signal lines to the plurality of display cells;
a plurality of second drive circuits to supply the plurality of second control signals via the plurality of second signal lines to the plurality of display cells; and
a control circuit to control the first and second drive circuits; wherein
each one second drive circuit of the plurality of second drive circuits is connected to a plurality of mutually adjacent signal lines of the plurality of second signal lines;
the control circuit comprises:
a signal source to generate a third control signal to cause each of the second control signals to be output, and
a first delay circuit to delay the third control signal with a first delay amount different for each of the second drive circuits to supply a delayed third control signal to each of the second drive circuits;
each one second drive circuit of the plurality of second drive circuits comprises a second delay circuit to delay the third control signal with a second delay amount different for each of the second signal lines being connected to a relevant one second drive circuit; and
the arithmetic unit sets the first and second delay amounts such that the delay amount of each of the second control signals is equal to a sum of the first and second delay amounts.

8. The calibration apparatus according to claim 6, wherein
the arithmetic unit:
sets the first delay amount based on each average value of luminance of each partial region corresponding to each of the second drive circuits in the test image; and
sets the second delay amount based on a value obtained by dividing a difference in the first delay amount of two mutually adjacent second drive circuits of the plurality of second drive circuits by a number of the second signal lines being connected to each one of the second drive circuits.

9. A calibration method to calibrate a display apparatus, wherein
the display apparatus comprises a display panel comprising a plurality of first signal lines along a plurality of rows, a plurality of second signal lines along a plurality of columns, and a plurality of display cells each being connected to one of the plurality of first signal lines and one of the plurality of second signal lines, wherein the plurality of display cells is selected for each of the rows by a plurality of first control signals applied via the plurality of first signal lines, and wherein the plurality of display cells displays of an image in accordance with a plurality of second control signals applied via the plurality of second signal lines, the plurality of second control signals indicating a grayscale of the plurality of display cells,
the calibration method comprising:
causing the display panel to display a test image;
photographing a screen of the display panel; and
setting a delay amount of the second control signal for the display cell included in a second region relative to the second control signal for the display cell included in a first region such that luminance of the second region satisfies a predetermined standard with respect to luminance of the first region, based on luminances of the first region and the second region of a test image that is displayed on the display panel and photographed.

10. The calibration apparatus according to claim 7, wherein
the arithmetic unit:
sets the first delay amount based on each average value of luminance of each partial region corresponding to each of the second drive circuits in the test image; and
sets the second delay amount based on a value obtained by dividing a difference in the first delay amount of two mutually adjacent second drive circuits of the plurality of second drive circuits by a number of the second signal lines being connected to each one of the second drive circuits.
